(19) United States
(12) Patent Application Publication
(10) Pub. No.: US 2010/0212011 A1
(43) Pub. Date: Aug. 19, 2010

(54) METHOD AND SYSTEM FOR SPAM REPORTING BY REFERENCE

(76) Inventors: Michal Andrzej Rybak, Bridgetown (BB); James Godfrey, Waterloo (CA); Daryl Joseph Martin, Waterloo (CA); Radu Alexandru Manea, Waterloo (CA); Suresh Chitturi, Irving, TX (US); Michael Ruarri Chapman, Waterloo (CA); Dejan Petronijevic, Mississauga (CA)

Correspondence Address: Research in Motion Corp/SLW;Attn: Glenda Wolfe, Building 6, Brazos East, Suite 100, 5000 Riverside Drive, Irving, TX, 75039, US

(21) Appl. No.: 12/695,738

(22) Filed: Jan. 28, 2010

Related U.S. Application Data
(60) Provisional application No. 61/148,757, filed on Jan. 30, 2009.

(51) Int. Cl. G06F 21/00; G06F 15/16

(52) U.S. Cl. 726/22; 709/206

(57) ABSTRACT

Methods and systems for spam reporting by reference are described. In one embodiment, an electronic message may be received by a mobile electronic device. A spam report may be transmitted from the mobile electronic device to a report server. The spam report may notify the report server that the electronic message is spam and include a reference to the electronic message without including the electronic message itself. The reference may be usable to identify the received message.

### RELATED APPLICATION

This non-provisional patent application claims the benefit of the filing date of U.S. Provisional Patent Application Ser. No. 61/148,757; filed Jan. 30, 2009; and entitled, “METHOD AND SYSTEM FOR SPAM REPORTING BY REFERENCE,” the contents of which are incorporated by reference herein.

### FIELD

This application relates to methods and systems for messaging, and more specifically to methods and systems for sending or receiving spam reports.

### BACKGROUND

Spam continues to proliferate on networks such as the Internet despite attempts to eliminate it or reduce its frequency. Spam annoys its recipients, and causes network operators to incur increased costs.

One way in which users are combating spam is by sending spam reports that indicate received e-mails are spam. The spam reports are sent to e-mail providers (e.g., internet service providers (ISPs)), operators or other entities such as, for example one or more anti-spam vendors, in hopes that future e-mails of a similar nature or from a same sender will be blocked. These spam reports typically include an indication that the particular e-mail is a spam report and include a copy of the entire e-mail that is believed to be spam. The recipient of the spam reports employs the spam reports from users to try to minimize the number of spam messages sent in the future, and may ultimately provide results to other e-mail providers, operators or other entities so that they can block or facilitate blocking of similar spam. Given the enormous amount of spam received by users of e-mail providers on a daily basis, a significant amount of network capacity may be devoted to incoming spam reports.

### BRIEF DESCRIPTION OF THE DRAWINGS

FIG. 1 is a block diagram of a system, according to an example embodiment;

FIG. 2 is a block diagram of an example mobile electronic device that may be deployed within the system of FIG. 1, according to an example embodiment;

FIG. 3 is a block diagram of an example message server that may be deployed within the system of FIG. 1, according to an example embodiment;

FIG. 4 is a block diagram of an example report server that may be deployed within the system of FIG. 1, according to an example embodiment;

FIG. 5 is a block diagram of an example spam reporting subsystem that may be deployed within the mobile electronic device of FIG. 1, according to an example embodiment;

FIG. 6 is a block diagram of an example spam report processing subsystem that may be deployed within the message server or report server of FIG. 1, according to an example embodiment;

FIG. 7 is a flowchart illustrating a method for spam reporting, according to an example embodiment; and

FIGS. 8 and 9 are flowcharts illustrating methods for spam report processing, according to example embodiments.

### DETAILED DESCRIPTION

Example methods and systems for spam reporting by reference are described. In the following description, for purposes of explanation, numerous specific details are set forth in order to provide a thorough understanding of example embodiments. It will be evident, however, to one of ordinary skill in the art that embodiments of the invention may be practiced without these specific details.

Mobile electronic devices receive a number of electronic messages. When one or more of the electronic messages are identified as being spam, a spam report may be sent. According to the present method and system, the spam report does not include the electronic message itself, but rather includes a reference to the electronic message. The reference enables a server that receives the spam report to ascertain information about the electronic message or otherwise identify the electronic message without having received an entirety of the electronic message in the spam report.

An ultimate recipient of the spam report that may be an entity different from the aforementioned server processes the spam report using the reference. The recipient has access to information about the electronic message, and uses the access and the reference to ascertain information about the electronic message. The ascertained information may be used to reduce the transmissions of future electronic messages that are spam.

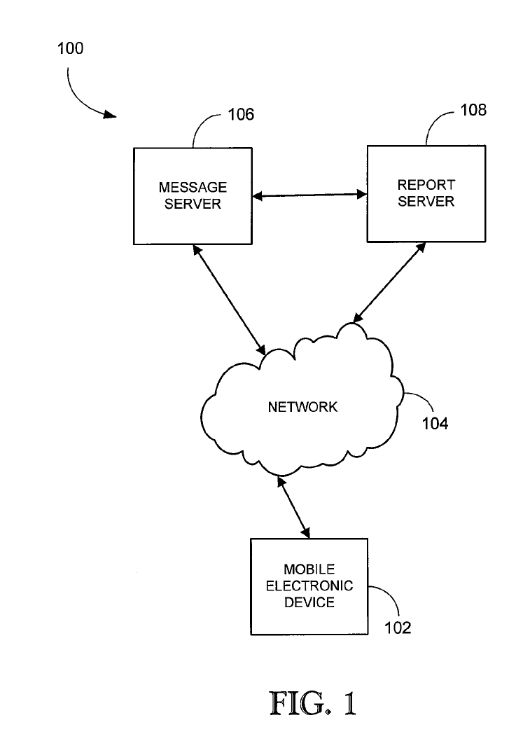

FIG. 1 illustrates an example system 100 comprising various entities or apparatuses. As shown, system 100 includes a mobile electronic device 102 that receives electronic messages from a message server 106 through a network 104. Typically, the received electronic messages include a number of electronic messages that are perceived by a user as being spam. In general, electronic messages that are unsolicited commercial messages or undesired bulk electronic messages are deemed spam. While it is very common for e-mail messages to be spam, other types of messages including short message service (SMS) messages, multimedia messaging service (MMS) messages, and instant messages (IMs) may also be spam.

When one or more received messages have been identified as spam by either a process on the mobile electronic device 102 or as indicated by a user of the mobile electronic device 102, a spam report is generated and transmitted through the network 104 to a recipient which may include the message server 106, a report server 108 or another entity. The server that receives and processes the spam report typically depends on a configuration of the system 100. The processing of the spam report is typically intended to improve the communication of future electronic messages by reducing spam.

The mobile electronic device 102 of the system 100 is a portable electronic device that enables a user to send and receive data, communicate with others through voice communications or otherwise, or both. The mobile electronic device 102 may include a communication portion (e.g., a transceiver apparatus or the like) configured to receive and transmit messages, and a processing portion (e.g., a microprocessor apparatus or the like) configured to process messages that are received by or that are intended to be transmitted by the communication portion.

The network 104 over which the mobile electronic device 102 is in communication with the message server 106, the report server 108, or both, may include a Global System for Mobile Communications (GSM) network, code division multiple access (CDMA), 3rd Generation Partnership Project (3GPP), an Internet Protocol (IP) network, a Wireless Application Protocol (WAP) network, a WiFi network, or an IEEE 802.11 standards network, as well as various combinations thereof. Other conventional and/or later developed wired and wireless networks may also be used.

The mobile electronic device 102 is in communication with the message server 106 to send and receive electronic messages. For example, the message server 106 may be a server device (e.g., computing device configured with a communication portion, a processing portion and a message server application) that receives electronic messages for a user of the mobile electronic device 102 and transmits the electronic messages through the network 104 to the mobile electronic device 102. When the user of the mobile electronic device 102 seeks to send an electronic message to another user, the electronic message is transmitted to the message server 106 and further transmitted through the network 104 to another message server associated with the intended recipient or, alternatively, directly to the intended recipient if the intended recipient is known or otherwise determined to be associated with the message server 106.

In some instances the report server 108 receives and processes spam reports from the mobile electronic device 102. However, in other instances the report server 108 receives a spam report from the mobile electronic device 102 and forwards the spam report to another entity (e.g., a mobile operator server, an anti-spam vendor server and the like) for processing that may enable or otherwise facilitate blocking or minimizing additional spam based on the reference in the spam report. The report server 108 may operate separately from the message server 106, in conjunction with the message server 106, or be embodied as part of the message server 106. Furthermore, although the system of FIG. 1 is illustrated as including one message server 106 and one report server 108, the system 100 may be configured with additional servers 106, 108. The report server 108 may provide information regarding spam to the message server 106 or to another entity (e.g., an application or service-specific server that is configured to provide application or service functionality to a client or a user agent that is executing on the mobile electronic device 102) in communication with network 104 to enable the message server 106 to improve its messaging.

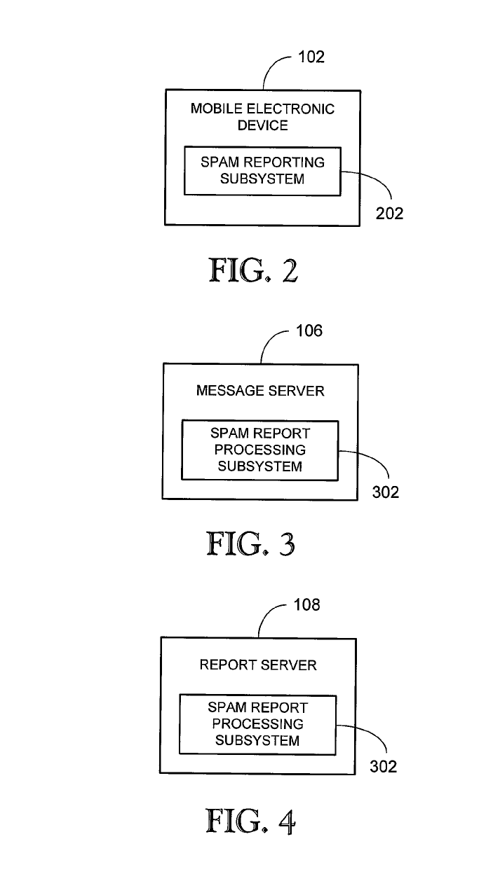

FIG. 2 illustrates an example mobile electronic device 102 that may be deployed in the system 100, or otherwise deployed in another system. The mobile electronic device 102 is shown to include a spam reporting subsystem 202 to transmit spam reports about the electronic messages received. In some instances, the spam reporting subsystem 202 may be configured in a server (e.g., an application server that provides functionality to an application or client executing on the mobile electronic device 102). The spam reports may not include the electronic message that has been identified as spam, but may instead include a reference to the electronic message. Despite not including the electronic message itself, a recipient (e.g., message server 106 or the report server 108) that receives the spam report can use the reference to ascertain information about the electronic message that has been identified as being spam. That is, the reference is usable by a recipient to identify the electronic message.

FIG. 3 illustrates an example message server 106 that may be deployed in the system 100, or otherwise deployed in another system. The message server 106 is shown to include a spam report processing subsystem 302 to process spam reports received from the mobile electronic device 102. The processing of the spam reports by the spam report processing subsystem 302 may enable the message server 106 to block, eliminate, or minimize communication of additional electronic messages that the spam report processing subsystem 302 identifies as being spam. The spam reports may otherwise be used to improve messaging functionality.

FIG. 4 illustrates an example report server 108 that may be deployed in the system 100, or otherwise deployed in another system. The report server 108 is shown to include the spam report processing subsystem 302 to process spam reports received from the mobile electronic device 102. In some instances, processing of the spam report by the report server 108 may comprise performing at least one of storing and forwarding of the spam report to another entity. The processing of the spam reports by the spam report processing subsystem 302 may enable the report server 108 to send out abuse reports or otherwise provide notification regarding the spam with appropriate details.

In some embodiments, the spam report processing subsystem 302 is either deployed in the message server 106 or the report server 108. The spam report processing subsystem 302 is typically deployed in the message server 106 when the report server 108 is not used in the system 100. The message server 106 then includes much of the functionality of the report server 108, and is then responsible for both transmitting electronic messages to the mobile electronic device 102 and receiving spam reports from the mobile electronic device 102. The spam report processing subsystem 302 is typically deployed in the report server 108 when the message server 106 and the report server 108 are separately deployed in the system 100. In other embodiments, the spam report processing subsystem 302 may be configured in both of the message and report servers 106, 108 or distributed across the message and report servers 106, 108.

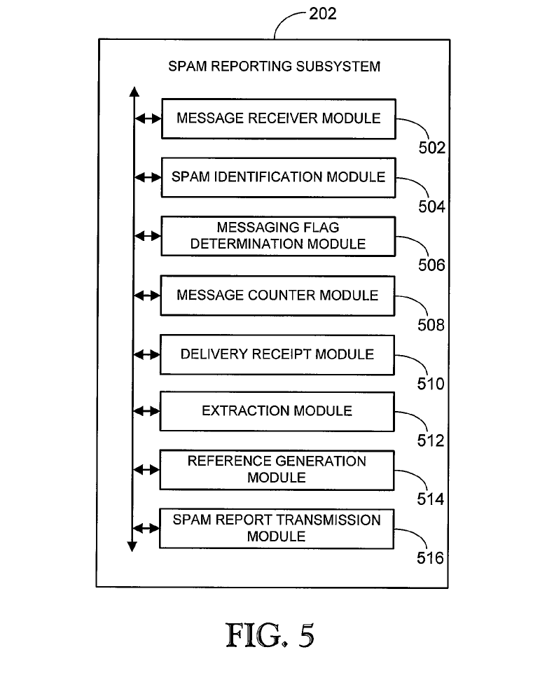

FIG. 5 illustrates an example spam reporting subsystem 202 that may be deployed in the mobile electronic device 102, or otherwise deployed in another system. One or more modules are included in the spam reporting subsystem 202 to enable spam reporting. The modules of the spam reporting subsystem 202 that may be include are a message receiver module 502, a spam identification module 504, a messaging flag determination module 506, a message counter module 508, a delivery receipt module 510, an extraction module 512, a reference generation module 514, and a spam report transmission module 516. Other modules may also be included.

A number of electronic messages for the mobile electronic device 102 are received by the message receiver module 502. The electronic messages received by the mobile electronic device 102 may be of one or more message types. In one embodiment, the electronic message is a SMS message. In another embodiment, the electronic message is a MMS message. In yet another embodiment, the electronic message is an e-mail message. In another embodiment, the electronic message is an IM.

While a number of the received messages are communications that are not spam (e.g., sent by someone from whom the recipient knows or would otherwise accept a message), others are spam or may be perceived as being spam. Electronic messages that are spam are typically unsolicited commercial messages or undesired bulk electronic messages. One or more of the received messages may be automatically identified by the spam identification module 504 as being spam messages. The automatic identification may, in one embodiment, be based on spam filtering technology. The spam identification module 504 may also receive identification from the user of one or more electronic messages as being spam. The actual electronic messages that have been identified as spam may or may not actually be spam. However, the spam identification module 504 at least identifies or receives identification that the received message is spam.

In some embodiments, the messaging flag determination module 506 is deployed within the spam reporting subsystem 202 to determine whether a report messaging flag is set to a content reporting setting or a reference reporting setting. When the report messaging flag is set to the content reporting setting, the spam reports include the electronic message that is identified as spam. When the report messaging flag is set to the reference reporting setting, the spam report includes a reference to the electronic message without including the electronic message itself. When the messaging flag determination module 506 is not deployed within the spam reporting subsystem 202, or is not set, the spam report may either automatically include the reference to the received message without the message itself or may include the electronic message within the spam report.

The report messaging flag may be based on at least one of a setting, rule and instruction (one or more of which may be defined, specified or otherwise established according to a policy) from the message server 106, the report server 108 or another entity. The setting may be the same for all content types of electronic messages or different for one or more of the types of electronic messages. The setting or policy may be different based on a per-service of the same content type.

In other embodiments, a decision on whether to report by reference or report by value may also vary based on the size of the electronic message on which the spam report is based. For example, small electronic messages are included in the spam report, while large electronic messages that are above a certain size threshold are reported by reference in the spam report.

One or more modules of the spam reporting subsystem 202 may be used to generate or otherwise obtain the reference to the electronic message.

In one embodiment, a message counter value associated with the received message is accessed by the message counter module 508 from a device message counter. The device message counter counts the number of electronic messages since device provisioning, during a particular day the electronic message was received, or may be otherwise based. The counter reference may be an absolute (e.g., sequential or continuous message counting since device provisioning or activation) or relative reference. Once accessed, the message counter value may then be used as the reference for the electronic message within the spam report.

In another embodiment, a delivery receipt for an electronic message is generated and a reference identifier from the delivery receipt is accessed by the delivery receipt module 510. The reference identifier identifies the delivery receipt for the particular electronic message. The reference identifier may then be used as the reference for the electronic message within the spam report.

In yet another embodiment, a uniform resource locator (URL) assigned by a multimedia messaging service center (MMSC) is extracted by the extraction module 512 from the electronic message. The URL (or a hash of the URL) may then be used as the reference for the electronic message within the spam report.

In still another embodiment, the reference generation module 514 generates the reference from the received electronic message. For example, a portion of the received message is hashed to generate a result that is used as the reference or as a part of the reference. In some embodiments, the reference generation module 514 generates the reference using: 1) the hashed message body of the electronic message; 2) an apparent sender address of the electronic message; and 3) a recipient address of the electronic message. The apparent sender address, the recipient address, or both, may also be hashed and used as part of the reference. The apparent sender address is an apparent sender e-mail address or an apparent sender telephone number. The recipient address is a recipient e-mail address or a recipient telephone number. In other embodiments, the portion includes a time associated with the electronic message.

In one embodiment, an apparent sender address and a recipient address of the received message is compressed by the reference generation module 514 to generate compressed address data. The compressed address data and the hashed message content may then be used as the reference.

Once the reference is obtained, the spam report transmission module 516 transmits the spam report through the network 104 to the report server 108. The spam report notifies the report server 108 that the electronic message is spam. The spam report also includes the reference to the electronic message without including the electronic message itself.

The reference is usable by the report server 108 or another entity to identify the electronic message by, for example, ascertaining one or more aspects of the electronic message. Aspects of the electronic message that may be ascertained include a size of the electronic message, message content, a message header, a time that the electronic message was sent from a message server, or the like. The report server 108 or other entity is able to ascertain the aspects by having access to information about the received message through communications with the message server 106.

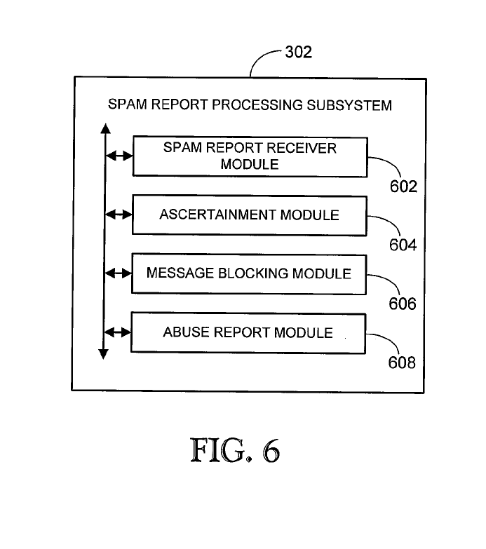

FIG. 6 illustrates an example spam report processing subsystem 302 that may be deployed in at least one of the message server 106, the report server 108, or otherwise deployed in another system (e.g., an anti-spam infrastructure comprising an anti-spam vendor's server or the like). One or more modules are included in the spam report processing subsystem 302 to enable processing of the spam reports. The modules of the spam report processing subsystem 302 which may be included are a spam report receiver module 602, an ascertainment module 604, a message blocking module 606, and an abuse report module 608. Other modules may also be included.

The spam report is received through the network 104 from the mobile electronic device 102 by the spam report receiver module 602. The spam report includes the notification that an electronic message is spam and the reference to the electronic message without including the electronic message itself. The reference includes a hashed portion of the electronic message, a time associated with the electronic message, a message counter value, a reference identifier for a delivery receipt, a URL assigned by the MMSC, or the like.

Once the spam report is received, the spam report processing subsystem 302 seeks additional information about the electronic message associated with the spam report. Since the spam report did not include the electronic message, but rather included the reference to the electronic message, the ascertainment module 604 is used to identify the electronic message (e.g., by ascertaining one or more aspects of the electronic message that the reference is indicative of or otherwise represents) using the reference. Once aspects of the electronic message identified in the spam report are ascertained by the ascertainment module 602, the spam report processing subsystem 302 may reconcile the aspects against electronic messages communicated by the message server 106 to identify the spam message being reported. The aspects of the electronic message may include a message body, a message time received, routing information, an apparent sender address, or the like. In one embodiment, the electronic message is retrieved by the ascertainment module 604 using the reference and then one or more aspects of the received message are then ascertained. In one embodiment where the report server 108 does not have access the electronic message, the reference is transmitted to the message server 106 and the electronic message or a portion of the electronic message is received in response. In another embodiment, the electronic message is received from the message server 106 prior to receiving the spam report. The electronic message is then identified based on the reference. A corresponding reference used by the ascertainment module 604 for identification may be determined on receipt of the electronic message, or at a later time. The ascertainment is then performed on the aspect of the received message.

In one embodiment where the spam report processing subsystem 302 is deployed in the message server 106, the message blocking module 606 may be included and additional electronic messages may be blocked based on the ascertaining. In another embodiment where the spam report processing subsystem 302 is deployed in the report server 108, the abuse report module 608 may be included and transmit an abuse report to the message server 106 based on the ascertaining. The abuse report may be exchanged with other network operators and other parties. In one embodiment, the abuse report is a message/feedback-report.

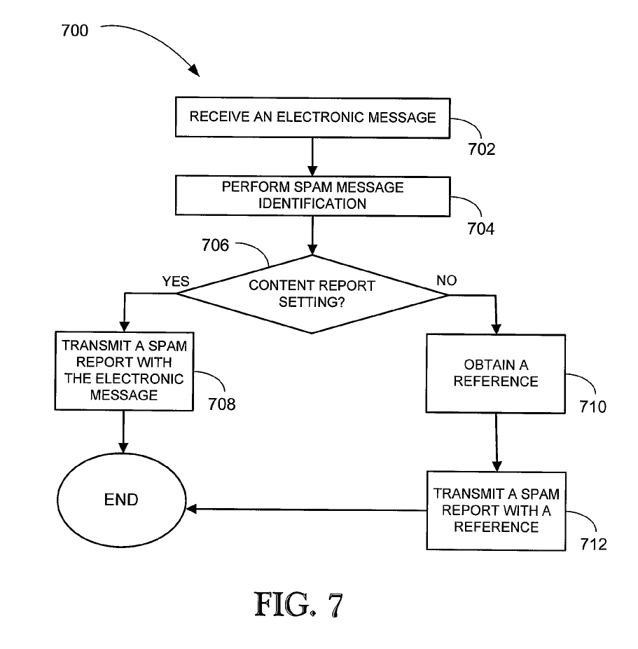

FIG. 7 illustrates a method 700 for spam reporting according to an example embodiment. The method 700 may be performed by the mobile electronic device 102 or one of the servers 106, 108 of the system 100 (see FIG. 1), or may be otherwise performed.

The electronic message is received on the mobile electronic device 102 at block 702. The electronic message is typically received from the message server 106 based on a preexisting relationship between the mobile electronic device 102 and the message server 106. For example, the message server 106 may be associated with an operator or a service provider of which the user is an authorized user.

In one embodiment, the received message is a SMS message. In another embodiment, the received message is a MMS message. In yet another embodiment, the received message is an e-mail message. In another embodiment, the received message is an IM.

The electronic message received by the mobile electronic device 102 may or may not be an actual spam message. Spam message identification may therefore be performed at block 704 to identify the received message as spam. In one embodiment, the mobile electronic device 102 identifies the received message as being a spam message. The identification may be based on certain aspects of the message such as apparent sender address, routing information, type of content, or the like. In another embodiment, identification of the received message as a spam message is received from the user of the mobile electronic device 102. The user may make such a determination by reviewing the electronic message. The user may then inform the mobile electronic device 102 of the identification through a user interface.

Once the electronic message has been identified as being spam, the mobile electronic device 102 may seek to transmit a spam report that identifies one or more electronic messages as being spam. In some embodiments, the information included in the spam report is not always fixed. Rather, a determination is made to determine what information will be included. An example implementation of such determination includes identifying whether a report messaging flag is set on the mobile electronic device 102 or one of the servers 106, 108. The report messaging flag is used, in one embodiment, to identify whether the spam report should include the actual electronic message or only a reference to the electronic message without the message itself. In another implementation, whether a spam report is to include a reference is specified by a policy that may be established by an operator, service provider, one of the servers 106, 108 or another entity. The policy defines at least one of settings, rules and instructions that govern spam report generation and handling (e.g., transmission, processing etc.) When the reference is used instead of the electronic message, the size of the spam report is smaller. Typically, the policy or report messaging flag is set to the reference report setting when the reference may be used to obtain information about the electronic message based, while the report messaging flag is set to the content report setting when the reference is not available, the electronic message has not been retained, or both.

A determination of whether the report messaging flag is set to (or whether the policy specifies) the content reporting setting or the reference reporting setting may be made at decision block 706. If the content reporting setting is identified, a spam report with the electronic message is transmitted to the report server 108 (or the message server 106) at block 708. If the reference reporting setting is identified, the reference for the received electronic message is obtained at block 710. When the report messaging flag is not present, the reference for the received electronic message is automatically obtained at block 710.

The reference may be obtained in a number of different ways. In one embodiment, the reference is generated from the received message at block 710. The generation of the reference may include hashing or compressing a portion of the received message (e.g., the message body) to generate a result. The reference generated from the received message includes at least the hashed result. In some embodiments, the portion includes a message body. In one embodiment, the reference further includes the apparent sender address and a recipient address. The apparent sender address may be an apparent sender e-mail address or an apparent sender telephone number. The recipient address may be a recipient e-mail address or a recipient telephone number.

In one particular embodiment, the apparent sender address and the recipient address of the received message are not hashed but are rather compressed to generate compressed address data. The reference then includes the hashed result and the compressed address data. In other embodiments, the portion includes a time associated with the electronic message. The associated time may be the time the electronic message was received by the mobile electronic device 102, the time the electronic message was sent from the message server 106, or a different time associated with the electronic message.

Another embodiment for obtaining the reference at block 710 is by accessing a message counter value associated with the received message from a device message counter. In one embodiment, the device message counter (e.g., 508 as shown in FIG. 5) counts an absolute number of electronic messages (e.g., the number of messages sent to or received by the mobile electronic device 102 since device provisioning). In another embodiment, the device message counter counts a relative number—the number of electronic messages sent to or received by the mobile electronic device 102 on a particular day or other fixed reference such as a time or event. Other counting methods may also be implemented. The device message counter may be synchronized with the message server 106.

Yet another embodiment for obtaining the reference at block 710 is by accessing the reference identifier for the delivery receipt associated with the received message. The delivery receipt may, in some embodiments, be generated and transmitted by the mobile electronic device 102 upon receipt of the electronic message.

Still another embodiment for obtaining the reference at block 710 is by extracting the URL from the received message. The URL may be assigned by the MMSC, or may be otherwise assigned.

Once the reference is obtained, the spam report including the reference is transmitted from the mobile electronic device 102 through the network 104 to the report server 108 (or the message server 106) at block 712. The spam report notifies the recipient that the electronic message is spam and includes the reference without including the electronic message itself. The reference is usable to identify the received message (e.g., by ascertaining one or more aspects of the received message). The spam report includes reference to a single electronic message or multiple electronic messages. The aspects that may be ascertained from the received message that has been identified as spam includes a size of the electronic message, message content, a message header, a time that the electronic message was sent from the message server 106, or the like. In one embodiment, the reference transmitted in the spam report is the electronic message counter value. In another embodiment, the reference transmitted in the spam report is the reference identifier associated with the delivery receipt. In yet another embodiment, the reference is the URL.

In an example embodiment, the method 700 may reduce the size of spam reports sent between the mobile electronic device 102 and the report server 108 (or the message server 106). The reduction may reduce the congestion on the network 104.

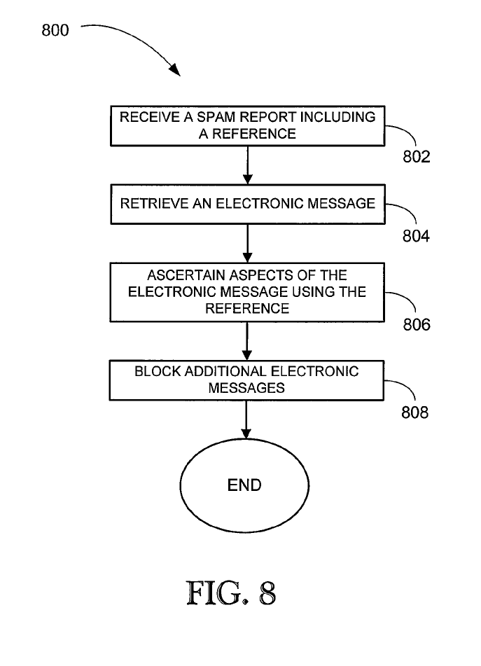

FIG. 8 illustrates a method 800 for spam report processing according to an example embodiment. The method 800 may be performed by the message server 106 of the system 100 (see FIG. 1), or may be otherwise performed. The method 800 may be performed when the system 100 does not include the report server 108 separately from the message server 106.

The spam report is received at block 802 through the network 104 from the mobile electronic device 102. The received spam report includes a notification that the electronic message (or electronic messages) is spam and the reference to the electronic message without including the electronic message itself. The reference included in the spam report may include the hashed or compressed portion of the electronic message, the time associated with the electronic message, the message counter value, the reference identifier for the delivery receipt, the URL assigned by the MMSC, or the like.

The electronic message may be identified and, optionally, retrieved using the reference (e.g., by reconciling aspects of the reference with the electronic message) at block 804. In some embodiments, spam message identification may be performed to obtain a comparison reference that is associated with the electronic message. The comparison reference may then be used for comparison with the reference contained in the spam report. The comparison references for all electronic messages may be obtained prior to or after receiving the spam report.

At block 806, one or more aspects of the electronic message are ascertained. The electronic message may have already been obtained using the reference at block 804, or one or more one or more aspects of the electronic message may be retrieved during the operations at block 806. The aspects of the electronic message that are ascertained may include, by way of example, a message body, a message time received, routing information, an apparent sender address, or the like. In one embodiment, any information from the electronic message that would enable the message server 106 to investigate the electronic message or the sender may be ascertained.

In some embodiments, one or more additional electronic messages may be blocked based on the ascertaining at block 808. The blocking of the additional electronic messages may prevent, minimize, or limit further spam from being sent by a certain sender, or of being a certain message type, or the like.

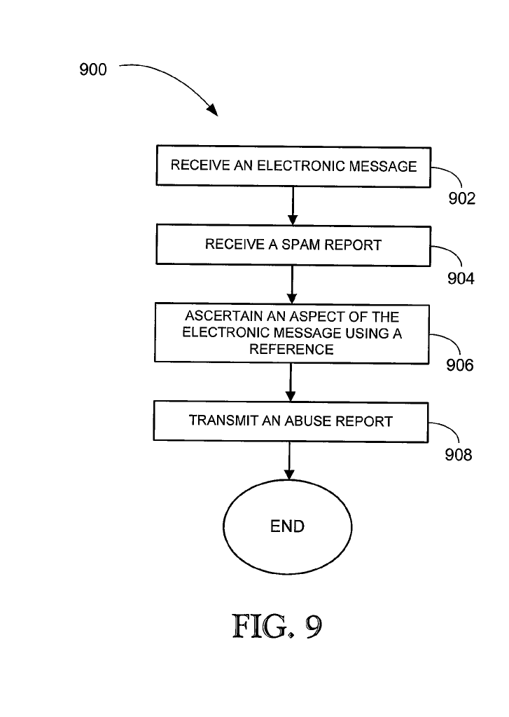

FIG. 9 illustrates a method 900 for spam report processing according to an example embodiment. The method 900 may be performed by the report server 108 of the system 100 (see FIG. 1), or may be otherwise performed. The method 900 may be performed when the system 100 includes both the message server 106 and the report server 108.

In some embodiments, a number of electronic messages are first received directly from the message server 106 at block 902. These electronic messages may be provided by the message server 106 substantially simultaneously with the transmission of the electronic messages to the mobile electronic device 102, or at a different time (e.g., at a delay, in a batch hourly, or the like) that is still in conjunction with the transmitting of the electronic messages to the mobile electronic device 102. The receipt of the electronic messages by the report server 108 may enable the report server 108 to process spam reports without further communicating with the message server 106. For such processing, some embodiments may perform spam message identification to obtain the comparison reference that is also associated with the electronic message. The comparison reference may then be used for comparison to a reference contained in a spam report.

The spam report is received at block 904 through the network 104 from the mobile electronic device 102. The received spam report includes the notification a particular electronic message (or more than one electronic messages) is spam. The spam report further includes the reference to the electronic message without including the electronic message itself. The reference included in the spam report may include a hashed or compressed portion of the electronic message, a time associated with the electronic message, a message counter value, a reference identifier for a delivery receipt, a URL assigned by the MMSC, or the like.

Once the spam report is received, the electronic message is identified according to the reference in the spam report. For example, the reference may be indicative of or representative of one or more aspects of the electronic message that may be ascertained at block 906. The aspects of the electronic message that are ascertained may include, by way of example, a message body, a message time received, routing information, an apparent sender address, or the like. In one embodiment, the aspects of the electronic message may be ascertained to investigate the source or the cause of the spam message.

The ascertainment is performed based on having either direct or indirect access to the electronic message. In one embodiment, the reference to the electronic message (or the references of multiple electronic messages) is transmitted to the message server 106 and the electronic messages are received from the message server 106 in response. One or more aspects of the received message are then ascertained using the reference. In another embodiment, the electronic message has previously been received during the operations performed at block 902 are identified based on the reference.

Depending on the implementation and configuration of the report server 108, an abuse report based on the ascertainment may be transmitted at block 908 to the message server 106, other message servers, or other report servers. In one particular embodiment, the abuse report is a message/feedback-report.

Certain systems, apparatus, applications or processes are described herein as including a number of modules. A module may be a unit of distinct functionality that may be presented in software, hardware, or combinations thereof. When the functionality of a module is performed in any part through software, the module includes a machine readable medium. The modules may be regarded as being communicatively coupled.

The inventive subject matter may be represented in a variety of different embodiments of which there are many possible permutations.

Methods and systems for spam reporting by reference have been described. Although embodiments of the present invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

What is claimed is:

1. A method comprising:
receiving an electronic message on a mobile electronic device;
generating a reference from the electronic message; and
transmitting a spam report from the mobile electronic device to a report server, the spam report notifying the report server that the electronic message is spam and including the reference without including the electronic message itself, the reference usable to identify the electronic message

2. The method of claim 1, wherein the generating of the reference comprises:
at least one of hashing and compressing a portion of the electronic message.

3. The method of claim 2, wherein the portion includes a message body of the electronic message.

4. The method of claim 3, wherein the generating of the reference further comprises augmenting the reference with at least one of an apparent sender address and a recipient address.

5. The method of claim 4, wherein the apparent sender address is an apparent sender e-mail address or an apparent sender telephone number.

6. The method of claim 2, wherein the generating of the reference further comprises:
compressing an apparent sender address and a recipient address of the electronic message to generate compressed address data, the reference including the hashed result and the compressed address data.

7. The method of claim 1, further comprising:
determining if a spam report policy defines a content reporting setting or a reference reporting setting;
wherein the spam report including the reference to the electronic message is transmitted when the spam report policy defines the reference reporting setting.

8. The method of claim 1, wherein the electronic message is a short message service (SMS) message, a multimedia messaging service (MMS) message, an e-mail message, or an instant message (IM).

9. The method of claim 1, wherein the reference is indicative of at least one of:
a size of the electronic message, message content, a message header and a time that the electronic message was sent from a message server.

10. A method comprising:
receiving a multimedia messaging service (MMS) message on a mobile electronic device;
extracting a uniform resource locator (URL) from the MMS message, the URL being assigned by a multimedia messaging service center (MMSC); and
transmitting a spam report from the mobile electronic device to a report server, the spam report notifying the report server that the MMS message is spam and including the URL without including the MMS message itself, the URL usable to identify the MMS message

11. A method comprising:
receiving a spam report on a sever from a mobile electronic device, the spam report including a notification that an electronic message received by the mobile electronic device is spam and a reference to the electronic message without including the electronic message itself;
and
transmitting the spam report to facilitate blocking of additional electronic messages based on the reference.

12. The method of claim 11, wherein the reference includes a hashed or compressed portion of a message, a time associated with the electronic message, a message counter value, a reference identifier for a delivery receipt, a URL assigned by a MMSC, or combinations thereof.

13. An apparatus comprising:
a communication portion configured to receive an electronic message; and
a processing portion configured generate a reference from the electronic message, the processing portion being further configured, in cooperation with the communication portion, to transmit a spam report from the mobile electronic device through a network to a report server, the spam report notifying the report server that the electronic message is spam and including the reference without including the electronic message, the reference usable to identify the electronic message

14. The apparatus of claim 13, wherein the communication portion and the processing portion are configured in a mobile electronic device.

15. The apparatus of claim 13, wherein the communication portion and the processing portion are configured in a server device.

16. The apparatus of claim 15, wherein the server device is configured as an application or service provider server.

17. A server device comprising:
a communication portion configured to receive a spam report from a mobile electronic device, the spam report including a notification that an electronic message received by the mobile electronic device is spam and a reference to the electronic message without including the electronic message itself; and
a processing portion configured, in cooperation with the communication portion, to transmit the spam report for facilitating blocking of additional electronic messages based on the reference.
